(19) United States
(12) Patent Application Publication
(10) Pub. No.: US 2021/0023573 A1
(43) Pub. Date: Jan. 28, 2021

(54) Fluid splitting device

(71) Applicant: Jerry Don Eakin, George Town, TX (US)

(72) Inventor: Jerry Don Eakin, George Town, TX (US)

(21) Appl. No.: 16/521,065

(22) Filed: Jul. 24, 2019

(51) Int. Cl. B05B 1/20

(52) U.S. Cl. CPC B05B 1/202

(57) ABSTRACT

A fluid splitting device to divide a fluid, may include a main housing to house the fluid splitting device; a main vertical channel to connect to an external source of the fluid; a main horizontal channel to connect to the main vertical channel to distribute the fluid; and a first channel, a second channel, and a third channel to connect the main horizontal channel to a respective a first nozzle, a second nozzle and a third nozzle.

### FIELD OF THE INVENTION

The present invention relates to a water splitter device in order to provide a multitude of nozzles from a single input source.

### BACKGROUND

There is a need for a device to provide fluid for example water to a multitude of applications simultaneously. The applications may include washing a car, cleaning a driveway or walk. These applications generally need to be applied over a period of time. It is possible to satisfy these applications on a one by one basis. However, this technique is costly in terms of time required to move the fluid delivery system around to the various applications. It would be more efficient in terms of time to be able to address all or a portion of the applications simultaneously.

### SUMMARY

A fluid splitting device to divide a fluid, may include a main housing to house the fluid splitting device; a main vertical channel to connect to an external source of the fluid; a main horizontal channel to connect to the main vertical channel to distribute the fluid; and a first channel, a second channel, and a third channel to connect the main horizontal channel to a respective a first nozzle, a second nozzle and a third nozzle.

The first channel, second channel and third channel may be connected to a first nozzle channel, a second nozzle channel and a third nozzle channel respectively which is connected to the first nozzle, the second nozzle and the third nozzle

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a front cross-sectional view of a fluid splitting device in accordance with the present invention;

FIG. 2 illustrates a side view of the fluid splitting device in accordance with the present invention;

FIG. 3 illustrates a perspective view of the fluid splitting device in accordance with the present invention.

### DETAILED DESCRIPTION

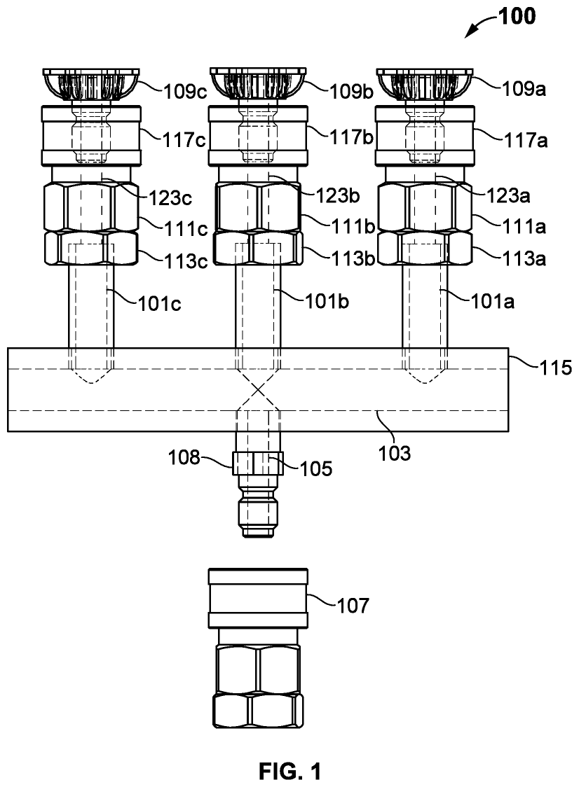

FIG. 1 illustrates a front cross-sectional view of the fluid splitting device 100 of the present invention and the back cross-sectional view of the fluid splitting device 100 is substantially a mirror image of the front cross-sectional view.

The fluid splitting device 100 of the present invention may include a main housing 115 which may include a multitude of channels/passageways in order to divert or direct the flow of the fluid from the main vertical channel 105 to the first output nozzle 109a, the second output nozzle 109b and the third output nozzle 109c. The housing 115 may include/define a main horizontal channel 103 which may connect to the first channel 101a, the second channel 101b and the third channel 101c and may connect to the main vertical channel 105 to facilitate the flow of the fluid from the main vertical channel 105 to the main horizontal channel 103. The main horizontal channel 103 diverts the fluid to the first channel 101a, the second channel 101b and the third channel 101c. The fluid then flows to the first nozzle channel 123a, the second nozzle channel 123b and the third nozzle channel 123c where the fluid flows to the first output nozzle 109a, the second output nozzle 109b and the third output nozzle 109c to be output from the fluid splitting device 100.

The fluid splitting device 100 of the present invention may transmit and divert fluid for example water into substantially equal portions from a fluid supply 107 to a multitude of output nozzles (of any number) which may be represented in the figures as a first output nozzle 109a, a second output nozzle 109b and a third output nozzle 109c.

The fluid supply device 107 which may be external to the fluid splitting device 100 may connect to a main vertical channel 107 which may be connected to transmit the fluid to a main horizontal channel 103, and the fluid supply device 107 may connect to a fluid supply connector 108 of the fluid splitting device 100 to connect the fluid splitting device 100 to the fluid supply device 107. The output nozzles namely the first output nozzle 109a, the second output nozzle 109b and the third output nozzle 109c may connect to the output tubes for example the first output tube 121a, the second output tube 121b and the third output tube 121c by virtue of the upper fasteners (which may include a first upper fastener 111a, a second upper fastener 111b and a third upper fastener 111c) and lower fasteners (which may include a first lower fastener 113a, the second lower fastener 113b and the third lower fastener 113c). The first output nozzle 109a, the second output nozzle 109b and the third output nozzle 109 may include in one embodiment the spray tips positioned 2″ apart creating an aggressive turbulence using the same amount of water as a single tip that hits the debris to be removed and performs a much more sufficient job than the standard device that is 3 to 5 times quicker than the standard device. The upper fasteners and the lower fasteners may include internal threads which may cooperate with threads of the output tube 121 and threads of the nozzle device 117.

The nozzle device which may include the first nozzle device 117a, the second nozzle device 117b, and the third nozzle device 117c and which may include a first nozzle channel 123a, a second nozzle channel 123b and a third nozzle channel 123c may provide a path for the fluid to flow from the first channel 101a, the second channel 101b and the third channel 101c to the first output nozzle 109a, the second output nozzle 109b and the third output nozzle 109c.

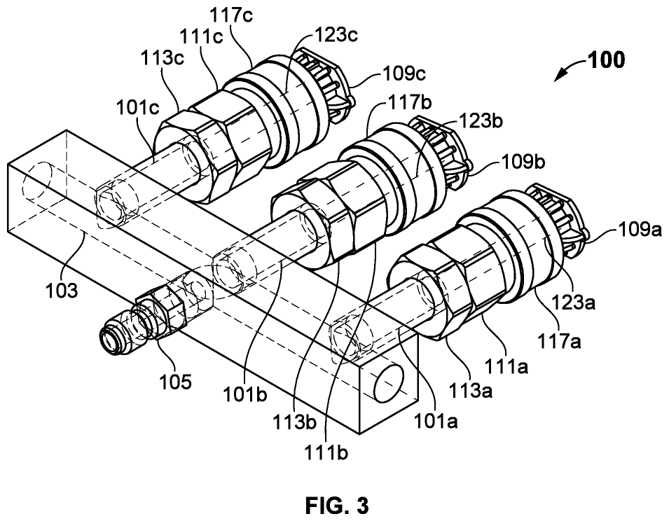

FIG. 3 illustrates a perspective view of the fluid splitting device 100 of the present invention. The fluid splitting device 100 of the present invention may include a main housing 115 which may include a multitude of channels/passageways in order to divert or direct the flow of the fluid from the main vertical channel 105 to the first output nozzle 109a, the second output nozzle 109b and the third output nozzle 109c. The housing 115 may include/define a main horizontal channel 103 which may connect to the first channel 101a, the second channel 101b and the third channel 101c and may connect to the main vertical channel 105 to facilitate the flow of the fluid from the main vertical channel 105 to the main horizontal channel 103. The main horizontal channel 103 diverts the fluid to the first channel 101a, the second channel 101b and the third channel 101c. The fluid then flows to the first nozzle channel 123a, the second nozzle channel 123b and the third nozzle channel 123c where the fluid flows to the first output nozzle 109a, the second output nozzle 109b and the third output nozzle 109c to be output from the fluid splitting device 100.

The fluid splitting device 100 of the present invention may transmit and divert fluid for example water into substantially equal portions from a fluid supply 107 to a multitude of output nozzles (of any number) which may be represented in the figures as a first output nozzle 109a, a second output nozzle 109b and a third output nozzle 109c.

The fluid supply device 107 which may be external to the fluid splitting device 100 may connect to a main vertical channel 107 which may be connected to transmit the fluid to a main horizontal channel 103, and the fluid supply device 107 may connect to a fluid supply connector 108 of the fluid splitting device 100 to connect the fluid splitting device 100 to the fluid supply device 107. The output nozzles namely the first output nozzle 109a, the second output nozzle 109b and the third output nozzle 109c may connect to the output tubes for example the first output tube 121a, the second output tube 121b and the third output tube 121c by virtue of the upper fasteners (which may include a first upper fastener 111a, a second upper fastener 111b and a third upper fastener 111c) and lower fasteners (which may include a first lower fastener 113a, the second lower fastener 113b and the third lower fastener 113c). The upper fasteners and the lower fasteners may include internal threads which may cooperate with threads of the output tube 121 and threads of the nozzle device 117.

The nozzle device which may include the first nozzle device 117a, the second nozzle device 117b, and the third nozzle device 117c and which may include a first nozzle channel 123a, a second nozzle channel 123b and a third nozzle channel 123c may provide a path for the fluid to flow from the first channel 101a, the second channel 101b and the third channel 101c to the first output nozzle 109a, the second output nozzle 109b and the third output nozzle 109c.

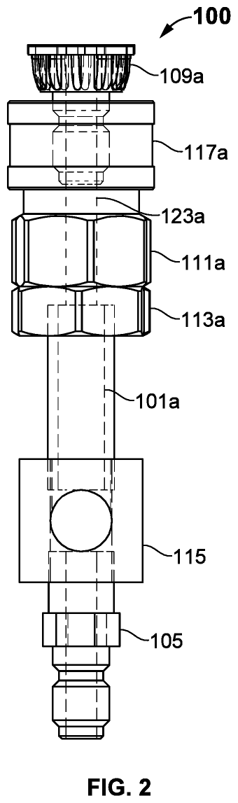

FIG. 2 illustrates a side view of the fluid splitting device 100 of the present invention and illustrates the first output nozzle 109a, the first nozzle device 117a, the first nozzle channel 123a, the first upper fastener 111a, the first lower fastener 113a, the first channel 101a, the main housing 115, and the main vertical channel 105.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A fluid splitting device to divide a fluid, comprising:
a main housing to house the fluid splitting device;
a main vertical channel to connect to an external source of the fluid;
a main horizontal channel to connect to the main vertical channel to distribute the fluid; and
a first channel, a second channel, and a third channel to connect the main horizontal channel to a respective a first nozzle, a second nozzle and a third nozzle.

2) A fluid splitting device to divide a fluid as in claim 1, wherein the first channel, second channel and third channel are connected to a first nozzle channel, a second nozzle channel and a third nozzle channel respectively which is connected to the first nozzle, the second nozzle and the third nozzle
